(19) United States
(12) Patent Application Publication
(10) Pub. No.: US 2018/0289581 A1
(43) Pub. Date: Oct. 11, 2018

(54) ADJUSTABLE MASSAGE ROLLER DEVICE

(71) Applicant: Samuel Zook, Sherman Oaks, CA (US)

(72) Inventor: Samuel Zook, Sherman Oaks, CA (US)

(21) Appl. No.: 15/480,890

(22) Filed: Apr. 6, 2017

(51) Int. Cl. A61H 7/00

(52) U.S. Cl. CPC A61H 7/00; A61H 2015/0007; A61H 2201/10; A61H 7/005

(57) ABSTRACT

An adjustable massage roller device for rolling massage of body parts includes a tube that defines an interior space. A bladder is positioned in the interior space. The bladder is substantially complementary to the interior space when the bladder is fully inflated. A housing is coupled to a respective opposing end of the tube. A power module and a pump are coupled to and positioned in the housing. The pump is operationally coupled to the power module. The pump is fluidically coupled to the bladder. The pump is configured to motivate air into the bladder, such that the bladder is inflated and occupies the interior space of the tube. The tube is configured to position between a body part of a user and a surface such that the tube is configured to roll on the body part as the user moves laterally relative to the surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM (EFS-WEB)

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure relates to massage devices and more particularly pertains to a new massage device for rolling massage of body parts.

### BRIEF SUMMARY OF THE INVENTION

An embodiment of the disclosure meets the needs presented above by generally comprising a tube that defines an interior space. A bladder is positioned in the interior space. The bladder is substantially complementary to the interior space when the bladder is fully inflated. A housing is coupled to a respective opposing end of the tube. A power module and a pump are coupled to and positioned in the housing. The pump is operationally coupled to the power module. The pump is fluidically coupled to the bladder. The pump is configured to motivate air into the bladder, such that the bladder is inflated and occupies the interior space of the tube. The tube is configured to position between a body part of a user and a surface such that the tube is configured to roll on the body part as the user moves laterally relative to the surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an adjustable massage roller device according to an embodiment of the disclosure.

FIG. 2 is a side view of an embodiment of the disclosure.

FIG. 3 is an end view of an embodiment of the disclosure.

FIG. 4 is a cross-sectional view of an embodiment of the disclosure.

FIG. 5 is a cross-sectional view of an embodiment of the disclosure.

### DETAILED DESCRIPTION OF THE INVENTION

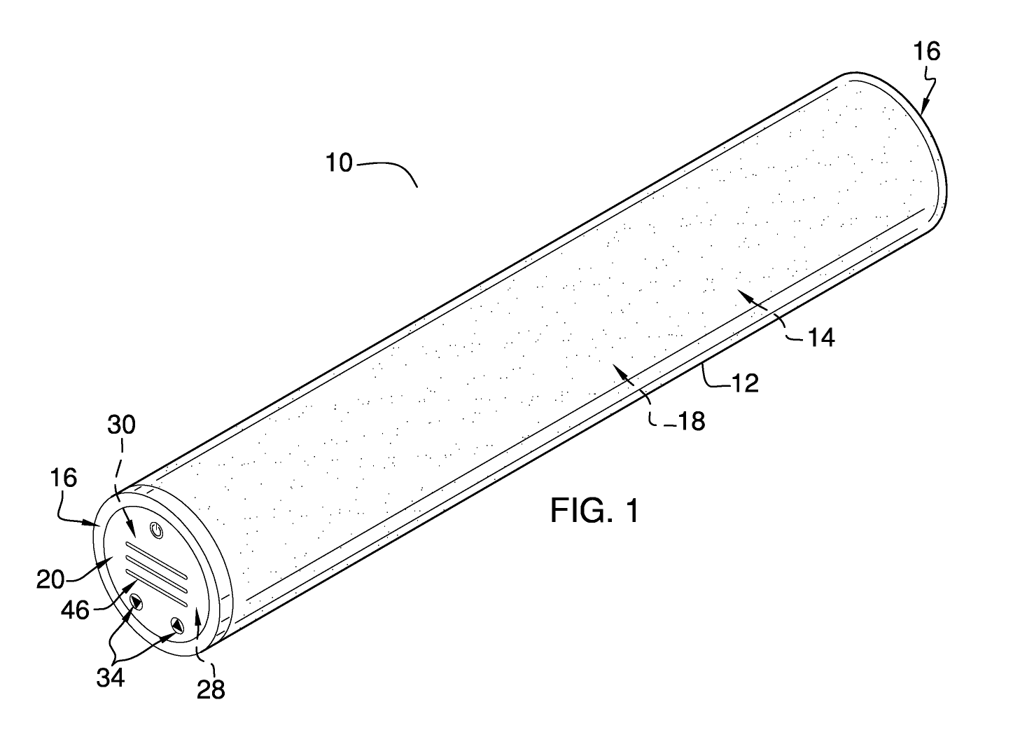

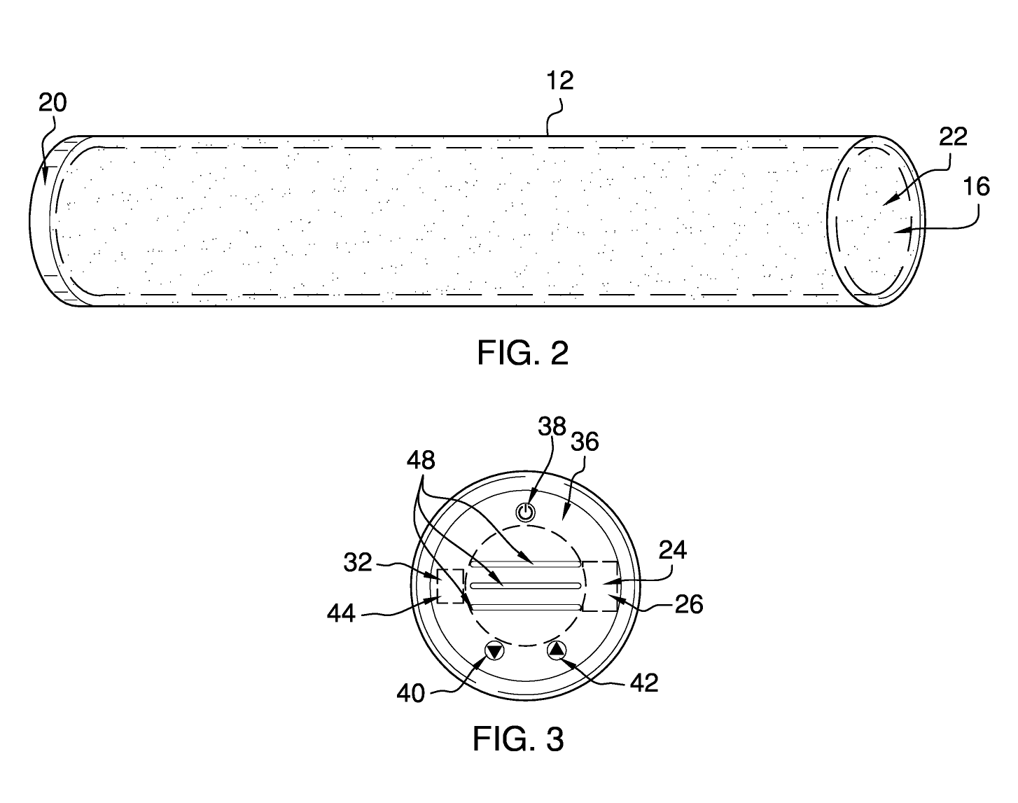

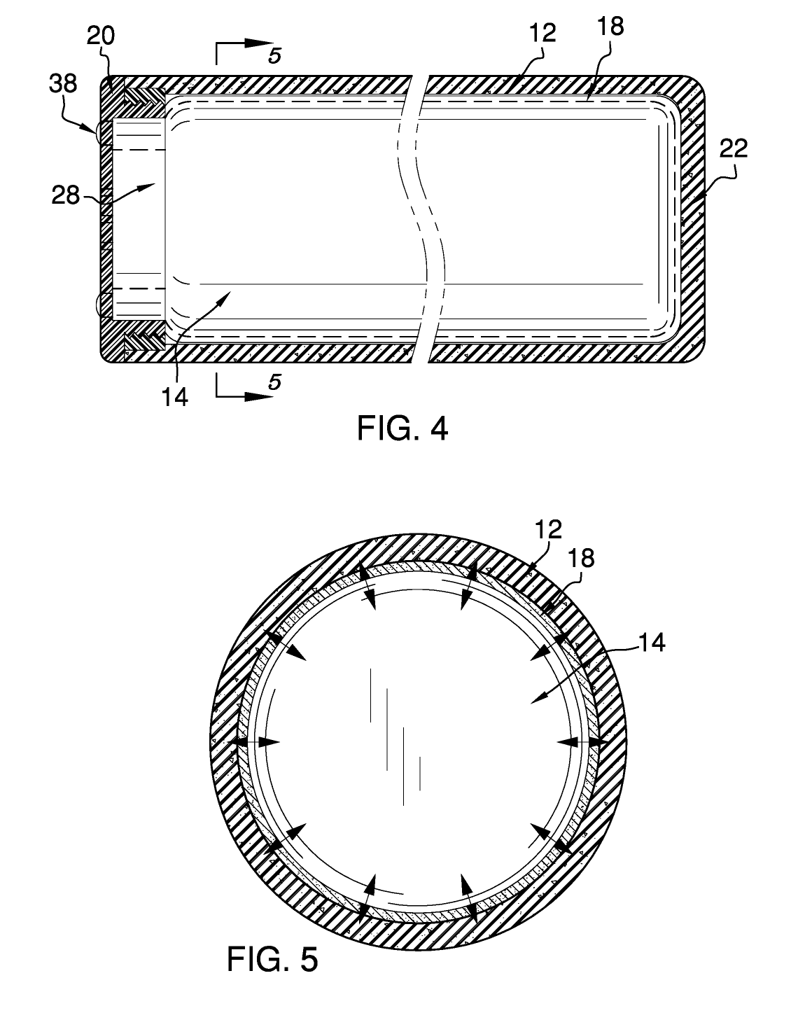

With reference now to the drawings, and in particular to FIGS. 1 through 5 thereof, a new massage device embodying the principles and concepts of an embodiment of the disclosure and generally designated by the reference numeral 10 will be described.

As best illustrated in FIGS. 1 through 5, the adjustable massage roller device 10 generally comprises a tube 12 that defines an interior space 14. The tube 12 has opposing ends 16. The tube 12 is substantially circularly shaped when viewed longitudinally. The tube 12 is resilient. The tube 12 comprises foam. The tube 12 comprises polyurethane.

A bladder 18 is positioned in the interior space 14. The bladder 18 is airtight, such that the bladder 18 is inflatable. The bladder 18 is substantially complementary to the interior space 14 when the bladder 18 is fully inflated. A housing 20 is coupled to a respective opposing end 16 of the tube 12. The housing 20 is complementary to the opposing end 16.

An endcap 22 is coupled to a respective opposing end 16 of the tube 12 distal from the housing 20. The endcap 22 is resilient. The endcap 22 comprises foam. The endcap 22 comprises polyurethane.

A power module 24 is coupled to and positioned in the housing 20. The power module 24 comprises at least one battery 26.

A pump 28 is coupled to and positioned in the housing 20. The pump 28 is operationally coupled to the power module 24. The pump 28 is fluidically coupled to the bladder 18.

A control module 30 is coupled to the housing 20. The control module 30 is operationally coupled to the power module 24 and the pump 28. The control module 30 is positioned to regulate the quantity of air contained in the bladder 18. The control module 30 comprises a microprocessor 32 that is operationally coupled to the power module 24 and the pump 28. An interface 34 is coupled to an exterior 36 of the housing 20 and operationally coupled to the microprocessor 32. The interface 34 is configured for entry of commands into the microprocessor 32. The interface 34 comprises an on/off button 38, a deflate button 40 and an inflate button 42.

In one embodiment, a receiver 44 is coupled to the microprocessor 32. The receiver 44 is wireless. The receiver 44 is configured to receive signals from a transmitter such that the signals are relayed to the microprocessor 32 to motivate the pump 28. In another embodiment, the receiver 44 is Bluetooth enabled.

A vent 46 is positioned through the housing 20. The vent 46 is configured for air to pass into the housing 20 such that the air is available to the pump 28 to motivate into the bladder 18. The vent 46 comprises a plurality of slots 48. The plurality of slots 48 comprises three slots 48.

In use, the pump 28 is configured to motivate air into the bladder 18. The vent 46 is configured for air to pass into the housing 20 such that the air is available to the pump 28 to motivate into the bladder 18. The bladder 18 is inflated and occupies the interior space 14 of the tube 12. The control module 30 is positioned to regulate the quantity of air contained in the bladder 18 to increase and decrease the firmness of the bladder 18. The tube 12 is configured to position between a body part of a user and a surface. The tube 12 is configured to roll on the body part as the user moves laterally relative to the surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An adjustable massage roller device comprising:
a tube defining an interior space, said tube having opposing ends;
a bladder positioned in said interior space, said bladder being airtight, such that said bladder is inflatable, said bladder being substantially complementary to said interior space when said bladder is fully inflated;
a housing coupled to a respective opposing end of said tube;
a power module coupled to and positioned in said housing;
a pump coupled to and positioned in said housing, said pump being operationally coupled to said power module, said pump being fluidically coupled to said bladder; and
wherein said pump is configured to motivate air into said bladder, such that said bladder is inflated and occupies said interior space of said tube, wherein said pump is configured to motivate additional air into said bladder to increase firmness of said bladder, such that said tube is configured for positioning between a body part of a user and a surface wherein said tube is configured to roll on the body part as the user moves laterally relative to the surface.

2. The device of claim 1, further including said tube being substantially circularly shaped when viewed longitudinally.

3. The device of claim 1, further including an endcap coupled to a respective said opposing end of said tube distal from said housing.

4. The device of claim 3, further including said tube and said endcap being resilient.

5. The device of claim 4, further including said tube and said endcap comprising foam.

6. The device of claim 5, further including said tube and said endcap comprising polyurethane.

7. The device of claim 1, further including said housing being complementary to said opposing end.

8. The device of claim 1, further including said power module comprising at least one battery.

9. The device of claim 1, further including a control module coupled to said housing, said control module being operationally coupled to said power module and said pump, wherein said control module is positioned to regulate the quantity of air contained in said bladder.

10. The device of claim 9, further including said control module comprising:
a microprocessor operationally coupled to said power module and said pump; and
an interface coupled to an exterior of said housing and operationally coupled to said microprocessor; and
wherein said interface is configured for entry of commands into said microprocessor.

11. The device of claim 10, further including said interface comprising an on/off button, a deflate button and an inflate button.

12. The device of claim 10, further including a receiver coupled to said microprocessor, said receiver being wireless, wherein said receiver is configured to receive signals from a transmitter such that the signals are relayed to said microprocessor to motivate said pump.

13. The device of claim 12, further including said receiver being Bluetooth enabled.

14. The device of claim 1, further including a vent positioned through said housing, wherein said vent is configured for air to pass into said housing such that the air is available for said pump to motivate into said bladder.

15. The device of claim 14, further including said vent comprising a plurality of slots.

16. The device of claim 15, further including said plurality of slots comprising three said slots.

17. An adjustable massage roller device comprising:
a tube defining an interior space, said tube having opposing ends, said tube being substantially circularly shaped when viewed longitudinally, said tube being resilient, said tube comprising foam, said tube comprising polyurethane;
a bladder positioned in said interior space, said bladder being airtight, such that said bladder is inflatable, said bladder being substantially complementary to said interior space when said bladder is fully inflated;
a housing coupled to a respective opposing end of said tube, said housing being complementary to said opposing end;
an endcap coupled to a respective said opposing end of said tube distal from said housing, said endcap being resilient, said endcap comprising foam, said endcap comprising polyurethane;
a power module coupled to and positioned in said housing, said power module comprising at least one battery;
a pump coupled to and positioned in said housing, said pump being operationally coupled to said power module, said pump being fluidically coupled to said bladder;
a control module coupled to said housing, said control module being operationally coupled to said power module and said pump, wherein said control module is positioned to regulate the quantity of air contained in said bladder, said control module comprising:
a microprocessor operationally coupled to said power module and said pump, and
an interface coupled to an exterior of said housing and operationally coupled to said microprocessor, wherein said interface is configured for entry of commands into said microprocessor, said interface comprising an on/off button, a deflate button and an inflate button;
a receiver coupled to said microprocessor, said receiver being wireless, wherein said receiver is configured to receive signals from a transmitter such that the signals are relayed to said microprocessor to motivate said pump, said receiver being Bluetooth enabled;
a vent positioned through said housing, wherein said vent is configured for air to pass into said housing such that the air is available for said pump to motivate into said bladder, said vent comprising a plurality of slots, said plurality of slots comprising three said slots;
wherein said pump is configured to motivate air into said bladder, such that said bladder is inflated and occupies said interior space of said tube, wherein said pump is configured to motivate additional air into said bladder to increase firmness of said bladder, such that said tube is configured for positioning between a body part of a user and a surface wherein said tube is configured to roll on the body part as the user moves laterally relative to the surface.
